(19) United States
(12) Patent Application Publication
(10) Pub. No.: US 2012/0299430 A1
(43) Pub. Date: Nov. 29, 2012

(54) ROTOR FOR MODULATED POLE MACHINE

(75) Inventors: Lars-Olov Pennander, Helsingborg (SE); Göran Nord, Helsingborg (SE)

(73) Assignee: HOGANAS AB (publ), Hoganas (SE)

(21) Appl. No.: 13/517,384

(22) PCT Filed: Dec. 20, 2010
(86) PCT No.: PCT/EP2010/070250

§ 371 Date: Aug. 8, 2012

Related U.S. Application Data
(60) Provisional application No. 61/289,298, filed on Dec. 22, 2009.

(51) Int. Cl. H02K 1/28; H02K 15/03

(52) U.S. Cl. 310/156.15; 29/598; 419/66

(57) ABSTRACT

A rotor for a modulated pole machine, the rotor being configured to generate a rotor magnetic field for interaction with a stator magnetic field of a stator of the modulated pole machine, wherein said rotor includes: a tubular support structure defining a circumferential mounting surface, the tubular support structure including a plurality of elongated recesses in the mounting surface, and a plurality of permanent magnets arranged at the mounting surface of the tubular support structure and magnetised in the circumferential direction of said rotor so as to generate the rotor magnetic field, the permanent magnets being separated from each other in the circumferential direction of the rotor by axially extending rotor pole sections for directing the rotor magnetic field generated by said permanent magnets in a radial direction, wherein at least one permanent magnet or one rotor pole section extends at least partly into one of the recesses.

### FIELD OF THE INVENTION

The invention relates to a rotor for modulated pole machines, more particular to a rotor for modulated pole machines that are easily manufacturable in large quantities.

### BACKGROUND OF THE INVENTION

Over the years, electric machine designs such as modulated pole machines, claw pole machines, Lundell machines and transverse flux machines (TFM) have become more and more interesting. Electric machines using the principles of these machines were disclosed as early as about 1910 by Alexandersson and Fessenden. One of the most important reasons for the increasing interest is that the design enables a very high torque output in relation to, for instance, induction machines, switched reluctance machines and even permanent magnet brushless machines. Further, such machines are advantageous in that the coil is often easy to manufacture. However, one of the drawbacks of the design is that they are typically relatively expensive to manufacture and that they experience a high leakage flux which causes a low power factor and a need for more magnetic material. The low power factor requires an up-sized power electronic circuit (or power supply when the machine is used synchronously) that also increases the volume, weight and cost of the total drive.

The modulated pole electric machine stator is basically characterised by the use of a central single winding that will magnetically feed multiple teeth formed by the soft magnetic core structure. The soft magnetic core is then formed around the winding, while for other common electrical machine structures the winding is formed around the tooth core section. Examples of the modulated pole machine topology are sometimes recognised as e.g. Claw-pole-, Crow-feet-, Lundell- or TFM-machines. The modulated pole machine with buried magnets is further characterised by an active rotor structure including a plurality of permanent magnets being separated by rotor pole sections. The active rotor structure is built up from an even number of segments, whereas half the number of segments is made of soft magnetic material and the other half number of segments is made from permanent magnet material. The permanent magnets are arranged so that the magnetization direction of the permanent magnets is substantially circumferential, i.e. the north and south pole, respectively, is pointing in a substantially circumferential direction.

Traditionally rotors are manufactured by producing a rather large number of individual rotor segments, typically 10-50. The assembly process is however complicated and time consuming, as a large number of components should be brought together resulting in a well defined air-gap to preserve the performance of the machine. The assembly process is further complicated by the opposing polarisation direction of the permanent magnet segments that will tend to repel the rotor pole sections from each other during the assembly.

WO2009116935 discloses a rotor and a method for manufacturing a rotor, where the number of individual parts are reduced thereby reducing the time needed to assembling the rotor. This approach however results in that the complexity and cost of the individual parts are increased. Furthermore, it may be difficult to reach good overall tolerances, since the components will show large variation in cross-section areas that may lead to undesired deformation like bending during heat-treatment. The thin integrated bridge sections may also cause strength problems during assembly especially, if the structure must be slightly deformed during assembly to fulfil demands on geometrical tolerances

It is generally desirable to provide a rotor for a modulated pole machine that is relatively inexpensive in production and assembly. It is further desirable to provide such a rotor that has good performance parameters, such as high structural stability, low magnetic reluctance, efficient flux path guidance low weight and inertia etc.

### SUMMARY

According to a first aspect, disclosed herein are embodiments of a rotor for a modulated pole machine, the rotor being configured to generate a rotor magnetic field for interaction with a stator magnetic field of a stator of the modulated pole machine, wherein said rotor comprises:
a tubular support structure defining a circumferential mounting surface, the tubular support structure comprising a plurality of elongated recesses in the mounting surface, the elongated recesses extending in an axial direction of the tubular support structure;
a plurality of permanent magnets magnetised in the circumferential direction of said rotor so as to generate the rotor magnetic field, the permanent magnets being separated from each other in the circumferential direction of the rotor by axially extending rotor pole sections for directing the rotor magnetic field generated by said permanent magnets in a radial direction,
   wherein at least one permanent magnet or at least one rotor pole section extends radially at least partly into one of the plurality of recesses. Hence at least one component chosen from a permanent magnet and a rotor pole section extends at least partly into one of the plurality of recesses, such that a part of the component extends out of the recess.

Consequently, in embodiments of the rotor described herein, the permanent magnets and rotor pole sections form a tubular rotor structure coaxial with the tubular support structure. One of the circumferential surfaces of the tubular rotor structure is connected to the circumferential mounting surface of the tubular support structure. To this end, some or all of the permanent magnets and/or some or all of the rotor pole sections project radially from said one of the circumferential surfaces of the tubular rotor structure and into respective recesses of the mounting surface of the tubular support structure.

Embodiments of the rotor described herein provide an efficient and reliable assembly process, where a well-defined air-gap is provided even with relatively large tolerances on the individual components, and even when the components to be assembled have limited strength and brittle behaviour.

In some embodiments, the plurality of recesses are adapted to allow the position of the at least one permanent magnet or at least one rotor pole section extending radially at least partly into one of the plurality of recesses to be adjusted radially, so as to allow the radial length of the part extending out of the recess to be adjusted.

A recess may be adapted to allow the position of said component to be adjusted radially, by having a depth that is greater than the depth needed for an average component. Thereby a component that is produced with a radial length above average, as a result of production variance, can be inserted deeper into the recess, allowing the radial length of the part extending out of the recess to be that of an average component. The reverse principle may be used for components produced with a radial length below average.

In some embodiments of the invention the at least one permanent magnet or at least one rotor pole section extending at least partly into one of the plurality of recesses is in contact with the two side walls of said recess, i.e. in direct contact with or separated from the two side walls by an adhesive.

The rotor may be any type of rotor such as an inner rotor, adapted to rotate radially inside an outer stator, or an outer rotor adapted to rotate around an inner stator.

The plurality of permanent magnets may be arranged so that every second magnet around the circumference is reversed in magnetisation direction. Thereby individual rotor pole sections may only interface with magnets showing equal polarity.

The recesses may be positioned periodically along the mounting surface of the tubular support structure. The walls of the recesses may extend in a radial direction into the tubular support structure. The permanent magnet or rotor pole section extending at least partly into one of the plurality of recesses may thus extend out of the recess in a radial direction.

In some embodiments the circumferential mounting surface is defined by an inner surface of the tubular support structure. This design is beneficial for outer rotors.

In some embodiments the circumferential mounting surface is defined by an outer surface of the tubular support structure. This design is beneficial for inner rotors.

The tubular support structure may comprise any number of recesses such as between 2 and 200, between 5 and 60 or between 10 and 30. In some embodiments of the invention all recesses are fitted with either a permanent magnet or a rotor pole section. The tubular support structure may have any axial length. In some embodiments of the invention the axial length of the tubular support structure corresponds to the axial length of the permanent magnets and/or the rotor pole sections. In some embodiments of the invention the recesses extend along the entire axial length of the tubular support structure. In some embodiments of the invention the recesses extends along a limited part of the axial length of the support structure. A recess may be formed by a first and a second parallel side wall extending in a radial direction into the tubular support structure connected by a third wall. In some embodiments of the invention the third wall is perpendicular to the first and the second wall. In some embodiments of the invention the third wall is curved, having a curve that approximately follows the curvature of the tubular support structure. The rotor may have any size. The recesses of the tubular support structure may be adapted to allow either the position of the rotor pole sections or the permanent magnets to be adjusted radially so as to allow the radial length of the part extending out of the recess to be adjusted.

The rotor, e.g. the tubular support structure, may comprise means for transferring the torque generated by the interaction between the rotor and the stator. In some embodiments the tubular support structure is connected to a shaft for transferring the generated torque. For example, the surface of the tubular support structure opposite the mounting surface for mounting the magnets and/or rotor pole sections may be used for mounting the rotor to a hub, a shaft, etc.

The cost of manufacturing any product is closely related to the precision requirements of the end product. High precision production requires either complex and expensive production techniques or a relative large rejection rate of the produced products, both approaches resulting in high production cost. To secure an efficient interaction between the rotor and the stator of a modulated pole machine, high precision requirements apply. This results in corresponding high precision requirements for the components of the rotor, e.g. the rotor pole sections and the permanent magnets. However, by supplying the rotor with a support structure comprising a plurality of recesses, a rotor pole section or permanent magnet may be adjusted radially into a recess of the tubular support structure, thereby allowing the length of the part extending radially out of the recess to be adjusted. This will lower the precision requirement of the rotor pole sections or permanent magnets, thereby lowering the production cost correspondingly. In some embodiments of the invention the gap between the component positioned in a recess and the back of the recess is filled with a suitable material, such as a suitable type of adhesive such as epoxy glue.

In some embodiments the support structure may comprise small recesses for transporting glue axially during the radial adjustment of the rotor pole pieces or permanent magnets in the recesses. The small recesses may provide respective channels for the glue to axially escape the areas under the pole piece or permanent magnet and thereby enhance the tolerance adjustment precision.

The tubular support structure may also serve to simplify the assembly process of the rotor parts, by providing a frame wherein the rotor pole section and permanent magnets can be inserted. The tubular support structure will additionally serve to provide a stiffer rotor, decreasing the risk of skewing of the rotor through use. As the tubular support structure can be produced with great precision the resulting rotors will have reduced geometrical variation increasing the overall quality of the product and reducing the risk of human errors. Thereby fewer rotors will need to be discarded.

It is an advantage of the invention that by having recesses in the tubular support structure, allowing the position of the permanent magnets or rotor pole sections to be modified, higher tolerances of individual components can be handled; this also includes the tolerance of the tubular support structure. It is a further advantage that the tubular support structure provides a frame for assembling a rotor according to the invention easily and with good concentricity.

In some embodiments the tubular support structure may be a single component or provided as a pluralit of segments or modules, e.g. sectioned in axial and/or circumferential direction. Similarly, some or each of the permanent magnets and/or pole-pieces may be modularized, e.g. sectioned in the axial direction or otherwise split in several components.

In some embodiments of the invention the rotor pole sections are made from a soft magnetic material such as soft magnetic powder. By making the rotor pole sections from soft magnetic powder the manufacturing of the rotor may be simplified and magnetic flux concentration, utilizing the advantage of effective three-dimensional flux paths, may be more efficient.

In some embodiments of the invention the tubular support structure is made of a non-magnetic material such as aluminium, plastic, e.g. extruded aluminium, injection moulded plastics etc. and/or the like, and/or other suitable non-magnetic materials. By producing the tubular support structure of a non-magnetic material the magnetic properties of the rotor is undisturbed.

According to a first aspect, the permanent magnets are fitted inside said recesses of said tubular support structure, and a rotor pole section is placed between two adjacent permanent magnets. By fitting the permanent magnets inside the recesses of said support structure, the permanent magnets extend radially beyond the rotor pole sections. This will allow a more efficient utilization of the magnetic flux generated by the permanent magnets.

In some embodiments of the invention the rotor pole sections are fitted inside said recesses of said support structure.

In some embodiments of the invention either the permanent magnets or the rotor pole sections are fitted inside the recesses of the tubular support structure by a frictional fit formed by the side walls of said recess. By using a frictional fit an easy and reliable method of securing the permanent magnets or rotor pole sections is provided. The frictional fit may be created by designing the recesses to be slightly smaller than the permanent magnets or rotor pole sections. An adjustment of the frictional forces may be facilitated by a controlled deformation of the recess walls, e.g. by some integrated design features like a lip of material that can be bent with desirable force small enough to prevent damaging the pole section or magnet.

According to a second aspect, the invention relates to a rotor pole section for a rotor as disclosed above wherein the rotor pole section when fitted in said recess extends radially from said recess defining a radial axis, where the rotor pole section comprises,
a first constant-width zone, forming a first end of said rotor pole section, adapted to at least partly be fitted in a recess of said support structure wherein said first constant-width zone has two parallel side walls so that the width of the rotor pole section in said first constant-width zone is constant,
a tapered zone starting at the point where the first constant-width zone ends, wherein said tapered zone has two non-parallel side walls such that the width of said rotor pole section in said tapered zone is non constant.

Hence, the tapered zones of two adjacent rotor pole sections form a slot opening with parallel walls for a permanent magnet, thereby facilitating a simple, low cost geometry of the expensive permanent magnet.

In some embodiments of the invention the side walls of the first constant-width zone are parallel with said radial axis.

In some embodiments of the invention the side walls of the tapered zone are non-parallel with said radial axis.

For the purpose of the present description, the length of a rotor pole section is defined as the dimension extending along the radial axis of the tubular support structure when the rotor pole section is fitted in the tubular support structure, the height of the rotor pole section is defined as the dimension extending along the axis of the tubular support structure, when the rotor pole section is fitted in the tubular support structure, and the width of the rotor pole section is defined as the dimension being perpendicular to the length and height of the rotor pole section.

The height of the rotor pole section may be constant through both the first constant-width zone and the tapered zone. The length of the first constant-width zone may approximately correspond to the depth of the recesses e.g. the height (in radial direction) of the side walls of the recess. In some embodiments of the invention the length of the first constant-width zone corresponds to between 2 and 30 percent of the total length of the rotor pole section. In some embodiments of the invention the length of the first constant-width zone corresponds to between 5 and 20 percent of the total length of the rotor pole section. In some embodiments of the invention the length of the first constant-width zone corresponds to between 8 and 12 percent of the total length of the rotor pole section.

The tapered zone may have any length. In some embodiments of the invention the length of the tapered zone corresponds to between 40 and 95 percent of the total length of the rotor pole section. In some embodiments of the invention the length of the tapered zone corresponds to between 60 and 90 percent of the total length of the rotor pole section. The length of the tapered zone may be determined by the radial length of the permanent magnets. In some embodiments of the invention the two side walls of the tapered zone are straight walls angled towards the centre radial axis such that the width of the rotor pole section is monotonously decreasing along the radial axis with increasing distance to the first constant-width zone; this design is advantageous when the rotor pole section is used in an outer rotor. In some embodiments of the invention the two side walls of the tapered zone are straight walls angled away from the centre radial axis such that the width of the rotor pole section is monotonously increasing along the radial axis with increasing distance to the first constant-width zone; this design is advantageous when the rotor pole sections is used in an inner rotor.

To secure a cylindrical shape of the rotor, in some embodiments of the invention, the rotor pole sections preferably comprise a tapered zone. As described above, the tapered zone secures that the width of the rotor pole section is expanded for inner rotors and reduced for outer rotors. However, by further having a first constant-width zone adapted to be positioned in a recess of the tubular support structure the assembly of the rotors utilizing the rotor pole sections can be simplified as the rotor pole sections can be inserted into the recesses in a movement along a radial axis. This has shown to be superior over pushing the rotor pole sections into the recesses using an axial movement as the height of rotor pole section typically is large, making them unstable in beginning of the insertion process. Thereby the production costs can be decreased. The first constant-width zone further serves to secure a firmer fit when the rotor pole sections are used for inner rotors.

In some embodiments of the invention the rotor pole section further comprises a second constant-width zone starting at the point where the tapered zone ends, and forming a second end of said rotor pole section, wherein the side walls of said second constant-width zone are parallel to each other, so that the width of said rotor pole section is constant in said second constant-width zone.

In some embodiment the two side walls of the second constant-width zone are parallel with the radial axis.

The second constant-width zone may have any length. In some embodiments of the invention the second constant-width zone has a length corresponding to between 2 and 20 percent of the total length of the rotor pole section. In some embodiments of the invention the second constant-width zone have a length corresponding to between 5 and 15 percent of the total length of the rotor pole section.

By having a second constant-width zone, the width of the space formed by two adjacent rotor pole sections can be decreased from the point where the second constant-width zone starts. Thereby a magnet placed in the space can be prevented from falling out of the pocket in a radial direction.

In some embodiments of the invention the height of the pole section is larger than the length, and the length is larger than the width.

According to a third aspect, the invention relates to a method of manufacturing a rotor pole section as disclosed above and in the following, using powder compaction, comprising the steps of:
obtaining a die having the inverse shape of a rotor pole section as disclosed above and in the following, comprising a first constant-width zone and a second constant-width zone;
filling said die with magnetic powder such as e.g. iron or iron based powder;
compressing the deformable magnetic powder in the die, e.g. using two or more punches, wherein at least one of the punches moves against the other punch along the radial axis of the resulting rotor pole section, partly entering at least one of the first constant-width zones or the second constant-width zone of the die, such that the length of at least one of the first constant-width zones or second constant-width zones of the resulting rotor pole section is reduced during the compaction.

The magnetic powder may e.g. be a soft magnetic Iron powder or powder containing Co or Ni or alloys containing parts of the same. The soft magnetic powder could be a substantially pure water atomised iron powder or a sponge iron powder having irregular shaped particles which have been coated with an electrical insulation. In this context the term “substantially pure” means that the powder should be substantially free from inclusions and that the amount of the impurities O, C and N should be kept at a minimum. The average particle sizes are generally below 300 μm and above 10 μm.

However, any soft magnetic metal powder or metal alloy powder may be used as long as the soft magnetic properties are sufficient and that the powder is suitable for die compaction.

The electrical insulation of the powder particles may be made of an inorganic material. Especially suitable are the type of insulation disclosed in U.S. Pat. No. 6,348,265 (which is hereby incorporated by reference), which concerns particles of a base powder consisting of essentially pure iron having an insulating oxygen- and phosphorus-containing barrier. Powders having insulated particles are available as Somaloy(R)500, Somaloy(R)550 or Somaloy(R)700 available from Hoganas AB, Sweden.

Thereby the rotor pole sections are efficiently made in the same operation by use of a powder forming method where the forming is made in a single compaction tool set up.

By having the constant-width zones in the die, the punches may move a variable degree into the zones without damaging the die. This allows a greater tolerance in the compressibility of the iron powder, further lowering the production costs.

According to a fourth aspect, the invention relates to a method for manufacturing a rotor for a modulated pole machine, said rotor comprising a tubular support structure defining a circumferential mounting surface, the tubular support structure comprising a plurality of elongated recesses positioned periodically along the mounting surface of the support structure in the mounting surface, the elongated recesses extending in an axial direction of the tubular support structure, each recess having two side walls, the rotor further comprising a plurality of permanent magnets separated in the circumferential direction form each other by axially extending rotor pole sections made from soft magnetic material, wherein the method comprises the steps of:
placing either a permanent magnet or a rotor pole section at least partly inside each of the recesses, the permanent magnets or rotor pole sections extending radially out of the recesses thereby forming a plurality of slots between two adjacent recesses
placing either a permanent magnet or a rotor pole section inside each of the formed slots.

In some embodiments of the invention the method further comprises the step of placing an air-gap fixture concentric with the support structure wherein a rotor pole section or a permanent magnet is adjusted radially in a recess so that the side of the permanent magnet or rotor pole section facing the air-gap-fixture contacts said air-gap-fixture.

The air-gap fixture is preferably cylindrical when assembling an outer rotor and tubular when assembling an inner rotor. The air-gap fixture may have any axial length such as an axial length approximately equal to the axial length of the support structure, an axial length lower than the support structure or an axial length exceeding the axial length of the support structure.

By using an air-gap fixture a fast and easy way of assembling a rotor according to the invention is provided, lowering the production cost. The air-gap fixture may additionally be used in an automated production process thereby further lowering the production costs. The air-gap fixture will as well serve to secure less variation in the end products.

In some embodiments of the invention the air-gap fixture further comprises a magnetic device for strengthen the contact pressure between a rotor pole section or a permanent magnet and the air-gap- fixture.

The magnetic device may be an arrangement of a magnetic flux circuit were the pole pieces or the permanent magnets form a part of said magnetic circuit so that the magnetic forces caused by said magnetic circuit can hold the pole pieces and permanent magnets closely to a fixture that represent the desired air-gap geometry of the application machine. The magnetic circuit may contain a magnetic field source that could be an electromagnet using a wire and coil holding controllable electric currents to generate the magnetic field or by external permanent magnets. The external permanent magnets may be the permanent magnets of the rotor. Additionally there may be radial, axially extending recesses in the surface of the magnetic fixture surface to further enhance the geometrical control of the rotor pole pieces and permanent magnets during the assembly process.

By using an air-gap fixture comprising a magnetic device, magnetic energy may be used to adjust the position of the rotor pole sections; this will further lower the production costs.

According to a fifth aspect the invention relates to an electrical, rotary machine, said machine comprising: a first stator core section being substantially circular and including a plurality of teeth, a second stator core section being substantially circular and including a plurality of teeth, a coil arranged between the first and second circular stator core sections, and a rotor as disclosed above and/or in the following, wherein the first stator core section, the second stator core section, the coil and the rotor are encircling a common geometric axis, and wherein the plurality of teeth of the first stator core section and the second stator core section are arranged to protrude towards the rotor; wherein the teeth of the second stator core section are circumferentially displaced in relation to the teeth of the first stator core section.

The different aspects of the present invention can be implemented in different ways including the rotors and rotor pole sections described above and in the following and further product means, each yielding one or more of the benefits and advantages described in connection with at least one of the aspects described above, and each having one or more preferred embodiments corresponding to the preferred embodiments described in connection with at least one of the aspects described above and/or disclosed in the dependent claims. Furthermore, it will be appreciated that embodiments described in connection with one of the aspects described herein may equally be applied to the other aspects.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIG. 1a shows an exploded, perspective view of a prior art modulated pole machine.

FIG. 1b shows a cross-sectional view of a prior art modulated pole machine.

FIG. 2a shows a tubular support structure of an outer rotor according to some embodiments of the invention.

FIG. 2b shows a more detailed view of a recess of an outer rotor according to some embodiments of the invention.

FIG. 2c shows a tubular support structure comprising a plurality of permanent magnets 203 of an outer rotor according to some embodiments of the invention.

FIG. 2d shows an outer rotor according to some embodiments of the invention.

FIG. 3 shows an inner rotor according to some embodiments of the invention.

FIG. 4 shows a rotor pole section 401 for an outer rotor according to some embodiment of the invention.

FIG. 5 shows a method of producing a rotor pole section 502 according to some embodiments of the invention.

FIG. 6a shows an outer rotor according to some embodiments of the invention.

FIG. 6b shows a more detailed view of a part of an outer rotor according to some embodiments of the invention.

FIG. 7a shows a rotor according to some embodiments of the invention.

FIG. 7b shows a more detailed view of a rotor according to some embodiments of the invention.

FIGS. 8a) and 8b) show an example of a magnetic air-gap fixture device.

FIG. 9 illustrates an example of a modulated pole machine. In particular, FIG. 9a shows a perspective view of the active parts of the machine including a stator 10 and a rotor 30, while FIG. 9b shows an enlarged view of a part of the machine.

FIG. 10 illustrates an example of the stator 10 of the modulated pole machine of FIG. 9.

FIG. 11 illustrates an example of a 3-phase modulated pole machine. In particular, FIG. 11a illustrates the active parts of an example of a 3-phase modulated pole machine, while FIG. 11b shows an example of a stator of the machine of FIG. 11a.

### DETAILED DESCRIPTION

In the following description, reference is made to the accompanying figures, which show by way of illustration how the invention may be practiced.

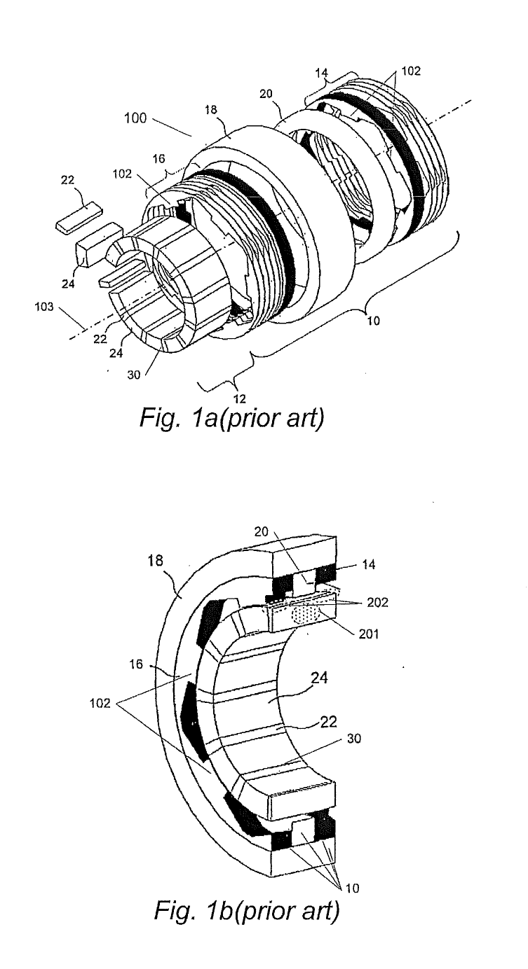

This invention is in the field of a modulated pole electric machine 100 of which one example is shown in FIG. 1a in a schematic, exploded, perspective view. The modulated pole electric machine stator 10 is basically characterised by the use of a central single winding 20 that will magnetically feed multiple teeth 102 formed by the soft magnetic core structure. The stator core is then formed around the winding 20 while for other common electrical machine structures the winding is formed around the individual tooth core section. Examples of the modulated pole machine topology are sometimes recognised as e.g. Claw-pole-, Crow-feet-, Lundell- or TFM-machines. More particularly the shown modulated pole electric machine 100 comprises two stator core sections 14, 16 each including a plurality of teeth 102 and being substantially circular, a coil 20 arranged between the first and second circular stator core sections, and a rotor 30 including a plurality of permanent magnets 22. Further, the stator core sections 14, 16, the coil 20 and the rotor 30 are encircling a common geometric axis 103, and the plurality of teeth of the two stator core sections 14, 16 are arranged to protrude towards the rotor 30 for forming a closed circuit flux path. The machine in FIG. 1 is of the radial type as the stator teeth protrudes in a radial direction towards the rotor in this case with the stator surrounding the rotor. However, the stator could equally well be placed interiorly with respect to the rotor which type is also illustrated in some of the following figures. The scope of invention as presented in the following is not restricted to any specific type of modulated pole electric machine and can equally well be applied to machines of both the axial and the radial type and for both interiorly and exteriorly placed stators relative to the rotor. Similarly, the invention is not restricted to single phase machines but can equally well be applied to multi phase machines.

The active rotor structure 30 is built up from an even number of segments 22, 24 whereas half the numbers of segments also called rotor pole sections 24 are made of soft magnetic material and the other half of number of segments of permanent magnet material 22. The state of art method is to produce these segments as individual components. Often the number of segments can be rather large typically of order 10-50 individual sections. The permanent magnets 22 are arranged so that the magnetization directions of the permanent magnets are substantially circumferential, i.e. the north and the south pole, respectively, is facing in a substantially circumferential direction. Further, every second permanent magnet 22, counted circumferentially is arranged having its magnetization direction in the opposite direction in relation to the other permanent magnets. The magnetic functionality of the soft magnetic pole sections 24 in the desired machine structure is fully three dimensional and it is required that the soft magnetic pole section 24 is able to efficiently carry varying magnetic flux with high magnetic permeability in all three space directions. A traditional design using laminated steel sheets will not show the required high permeability in the direction perpendicular to the plane of the steel sheets and its here beneficial to use a soft magnetic structure and material that shows a higher magnetic flux isotropy than a state of art laminated steel sheet structure.

FIG. 1b shows the same radial modulated pole electric machine as from FIG. 1 but in a cross-sectional view of the assembled machine showing more clearly how the stator teeth 102 extend towards the rotor and how the stator teeth of the two stator core sections 14, 16 are rotationally displaced in relation to each other.

In the following, examples of rotors will be described in greater detail that may be used as a part of the modulated pole electric machine shown in FIGS. 1a-b. It should be understood that the rotors described in this application may be used together with stators of modulated pole machines of different types than the one described above.

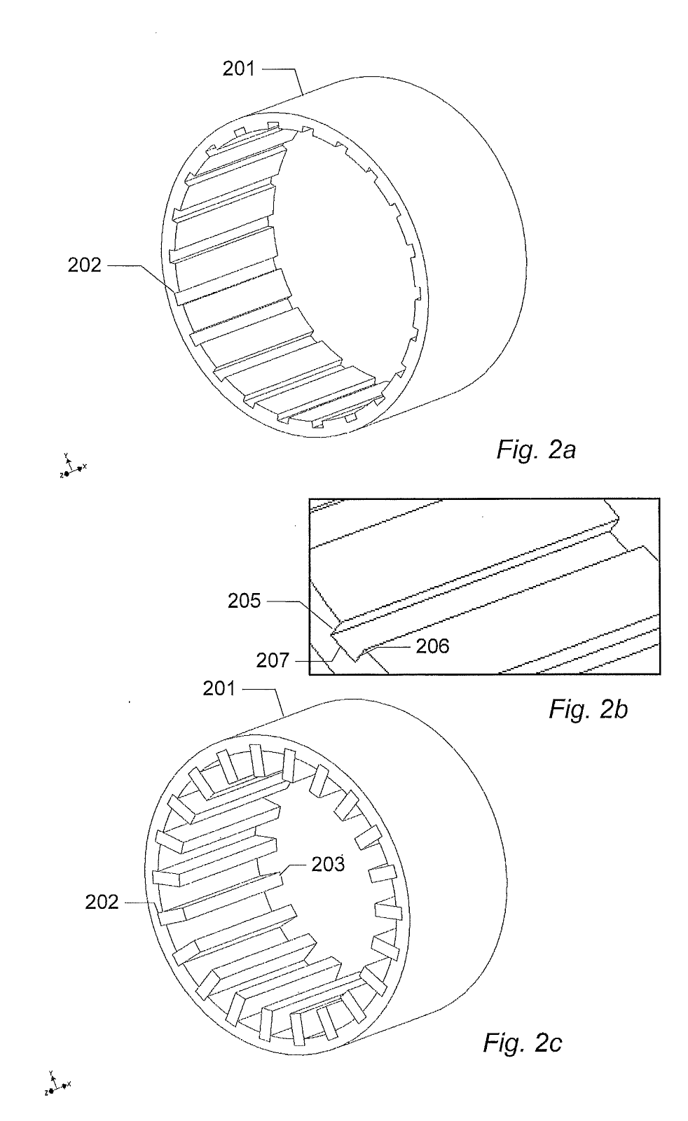

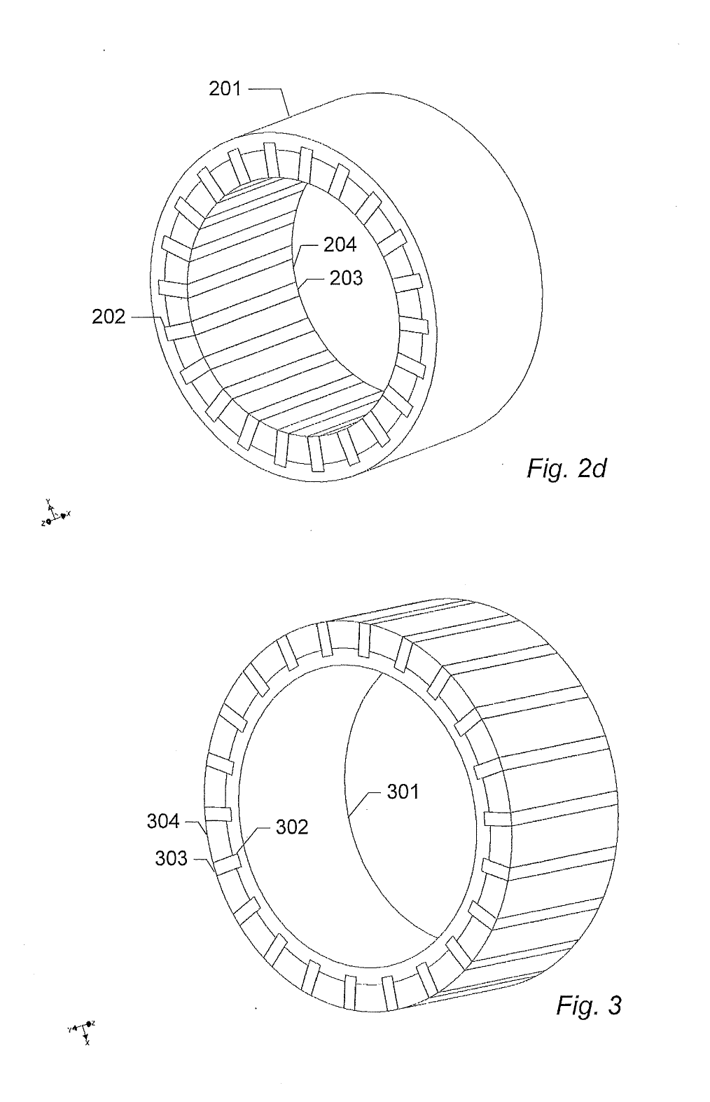

FIG. 2a shows a tubular support structure 201 of an outer rotor according to some embodiments of the invention. The tubular support structure 201 has a radius and a height, where the height extends along an axial axis of the tubular support structure 201. The tubular support structure 201 comprises a plurality of recesses 202 positioned periodically around the periphery of the support structure 201 in a circumferential mounting surface, being the inner surface of the tubular support structure 201. The tubular support structure 201 may be made of a non-permeable material e.g. a non-magnetic material such as aluminium or plastic. The plurality of recesses 202 extend in an axial direction of the tubular support structure. FIG. 2b shows a more detailed view of a recess. The recess comprises two parallel side walls 205 and 206 extending in a radial direction into the tubular support structure. The two parallel side walls 205 and 206 are connected by an end wall 207. The recess extends through the entire height of the tubular support structure 201.

FIG. 2c shows a tubular support structure comprising a plurality of permanent magnets 203 of an outer rotor according to some embodiments of the invention. Each of the plurality of recesses is fitted with a permanent magnet 203. The permanent magnets 203 may be secured in the recesses 202 by a frictional fit and/or any kind of fastening means such as a suitable type of glue.

FIG. 2d shows an outer rotor according to some embodiments of the invention. The outer rotor comprises a tubular support structure 201, a plurality of permanent magnets 203 and a plurality of rotor pole section 204.

The rotor pole sections 204 are fitted into the slots formed by the permanent magnets fitted inside the recesses 202 of the support structure 201. The rotor pole sections 204 may be fastened to the permanent magnet and/or support structure by a frictional fit formed by the permanent magnets and/or any type of fastening means e.g. a suitable type of glue. As the permanent magnets 203 are fitted into the recesses 202 of the support structure 201, they extend radially further outwards than the rotor pole sections 204. Thereby a greater portion of the magnetic field generated by the permanent magnets 203 can be utilized by the polar sections to generate the rotor magnetic field. This will decrease the magnetic requirements of the permanent magnets, so that smaller permanent magnets may be used, lowering the production costs. FIG. 3 shows an inner rotor corresponding to the outer rotor shown in FIG. 2d.

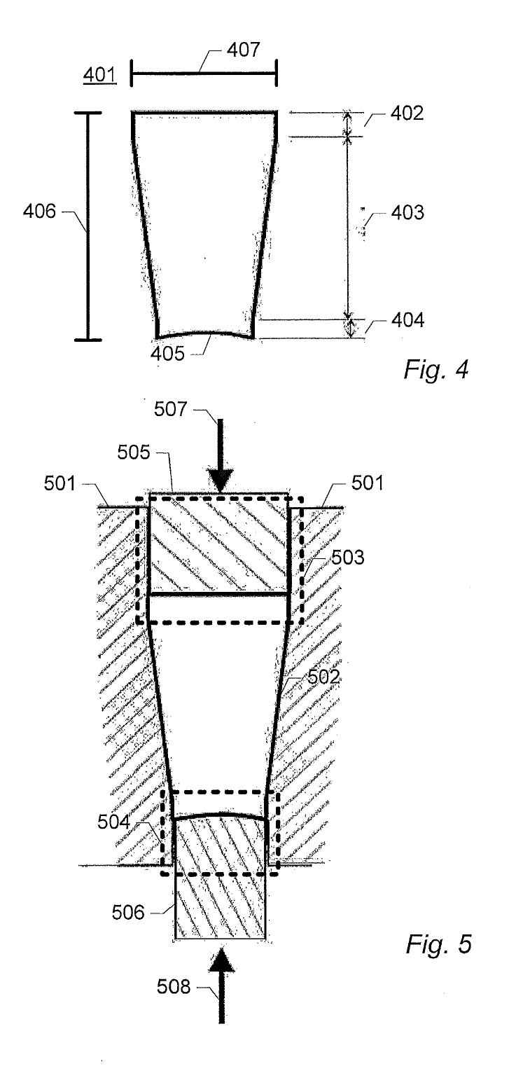

FIG. 4 shows a rotor pole section 401 for an outer rotor according to some embodiments of the invention. The rotor pole section 401 has a width 407 and a length 406. The rotor pole section 401 comprises three zones: a first constant-width zone 402, a tapered zone 403 and a second constant-width zone 404. The first constant-width zone 402 is adapted to at least partly be fitted in a recess of a support structure. The first constant-width zone 402 comprises two side walls being parallel to a radial axis of the rotor pole section 401, thereby securing that the width of the rotor pole section 401 is constant in the first constant-width zone 402. The length of the first constant-width zone may approximately correspond to the depth of the recesses e.g. the extent of the two side walls of the recesses. The tapered zone 403 comprises two straight side walls having an equal but opposite angle in regards to an radial axis of the rotor pole section 401, so that the width in the tapered zone is monotonically decreasing with increasing distance to the first constant-width zone 402. However, in other embodiments the side walls of the tapered zone is mirrored so that the width of the rotor pole section in the tapered zone is monotonically increasing with increasing distance to the first constant-width zone 402. The second constant-width zone 404 comprises two side walls being parallel to a radial axis of the rotor pole section 401, thereby securing that the width of the rotor pole section 401 is constant in the second constant-width zone. The second constant-width zone may further comprise a concave end 405, when the rotor pole section is used for an outer rotor and a convex end when the rotor pole section is used for an inner rotor. In some embodiments of the invention the rotor pole section only comprises a first constant-width zone 402 and a tapered zone 403.

FIG. 5 illustrates a method of producing a rotor pole section 502 according to some embodiments of the invention. The rotor pole section 502 is manufactured by filling a die 501 with iron or iron-based powder, and by compressing the iron powder with two punches 505 and 506. The die 501 has the inverse shape of the desired rotor pole section e.g. as shown in FIG. 4, with the difference that the length of the first and second constant-width zones 503 and 504 of the die 501 are extended. This enables the punches 505 and 506 to move in an radial direction of the resulting rotor pole section 502, partly entering the first and second constant-width zones 503 and 504 of the die 501, thereby compressing the iron powder in the die 501, forming the rotor pole section 502.

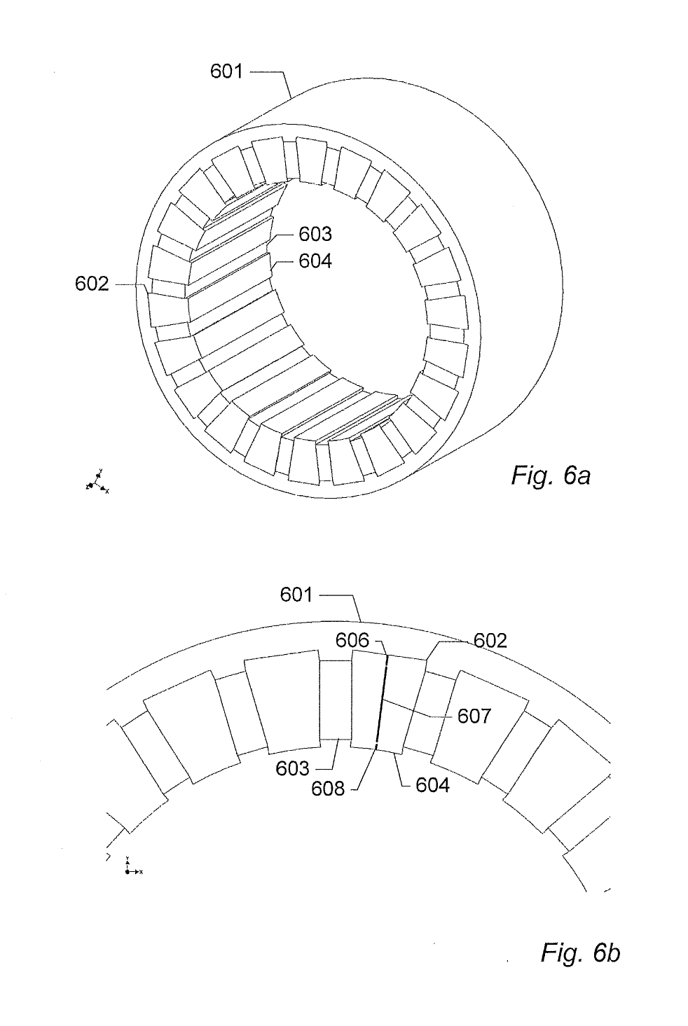

FIG. 6a shows an outer rotor according to some embodiments of the invention. The outer rotor comprises a tubular support structure 601, a plurality of permanent magnets 603 and a plurality of rotor pole sections 604 as shown in FIG. 4. The tubular support structure comprises a plurality of recesses 602 positioned periodically around the periphery of the support structure 601. The rotor pole sections 604 are fitted into the plurality of recesses 602 of the tubular support structure 601 and the permanent magnets 603 are fitted into the slots formed by two adjacent rotor pole sections 604.

FIG. 6b shows a more detailed view of a part of the outer rotor shown in FIG. 6a. FIG. 6b shows how the shape of the rotor pole sections 604 fitted in the recesses 602 of the tubular support structure 601 influences the space formed by two adjacent rotor pole sections 604. The tapered zone 607 of the rotor pole sections 604 secures that the width of the space formed between two adjacent rotor pole sections 604 is constant along the tapered zone 607 of the rotor pole sections 204. This enables a permanent magnet 605 having a constant width to be fitted in the space. By providing the rotor pole sections 604 with a second constant-width zone 608, the width of the space formed between two adjacent rotor pole sections 604, is decreased along the second constant-width zone 608 of the rotor pole sections 604. This secures the permanent magnets 603 enclosed in the space from sliding in a radial direction out of the rotor.

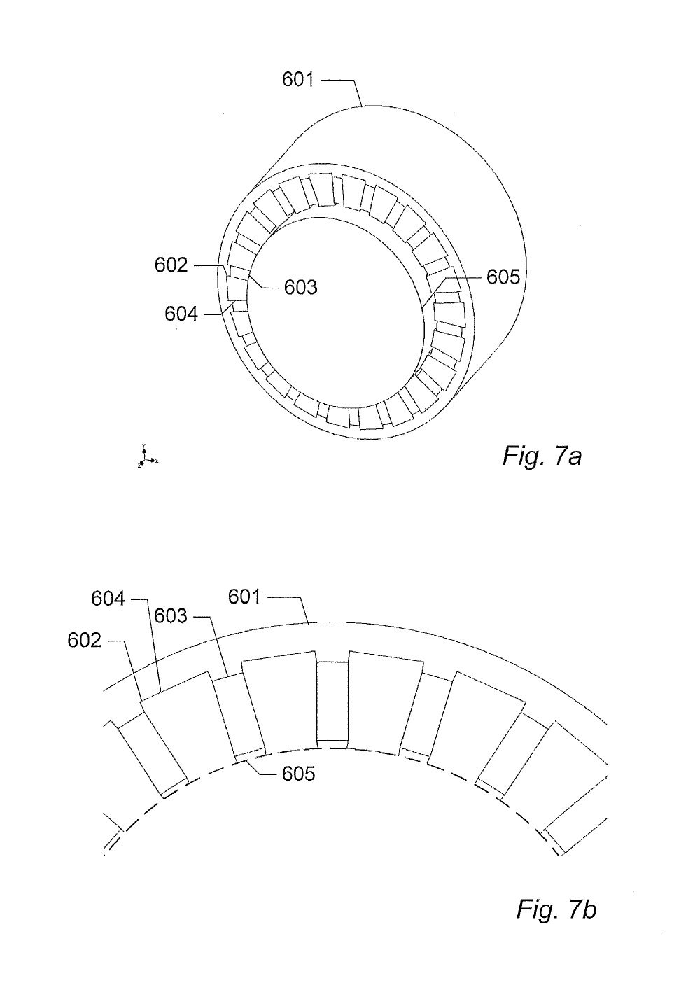

FIG. 7a shows a rotor according to some embodiments of the invention, further comprising an air-gap fixture 605. The air-gap fixture may secure the correct positioning of the rotor pole sections during manufacturing of the rotor. The air-gap fixture 605 may have a cylindrical shape or alternatively a cone shape when assembling an outer rotor, and a tubular shape when assembling an inner rotor. The air-gap fixture 605 may be used to adjust the rotor pole sections 604 radially in the recesses 602. The air-gap fixture may comprise a magnetic device enabling magnetic energy to be used to adjust the radial position of rotor pole sections 604 in the recesses 602. After assembling the rotor, the air-gap fixture may be removed. FIG. 7b shows a more detailed view of FIG. 7a. By using an air-gap fixture a fast and easy way of assembling a rotor according to the invention is provided, lowering the production cost.

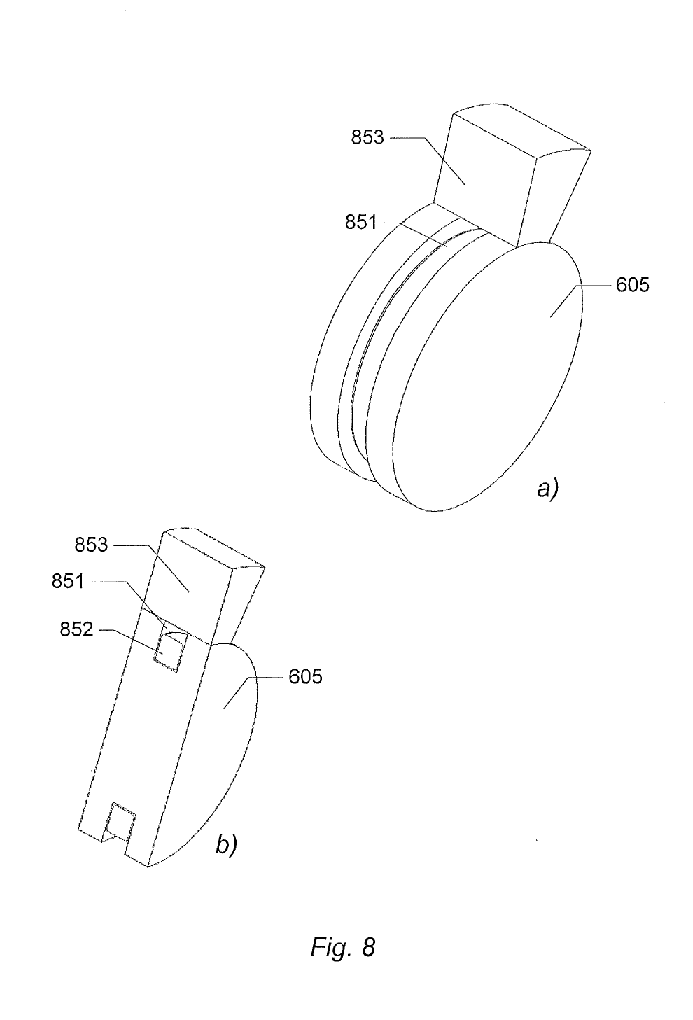

FIGS. 8a) and 8b) show an example of a magnetic air-gap fixture device. The magnetic air-gap fixture 605 comprises a generally cylindrical body having a circumferential recess 851 for accommodating a coil 852 for providing a controllable magnetic field for keeping the rotor pole sections 853 in place.

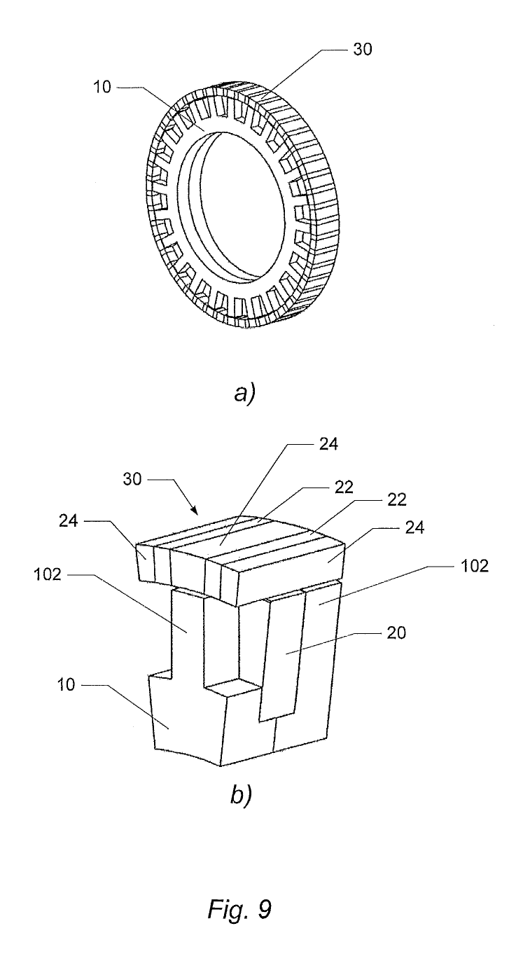

FIG. 9 illustrates an example of a modulated pole machine. In particular, FIG. 9 shows the active parts of a single phase, e.g. a one-phase machine or a phase of a multi-phase machine. FIG. 9a shows a perspective view of the active parts of the machine including a stator 10 and a rotor 30. FIG. 9b shows an enlarged view of a part of the machine.

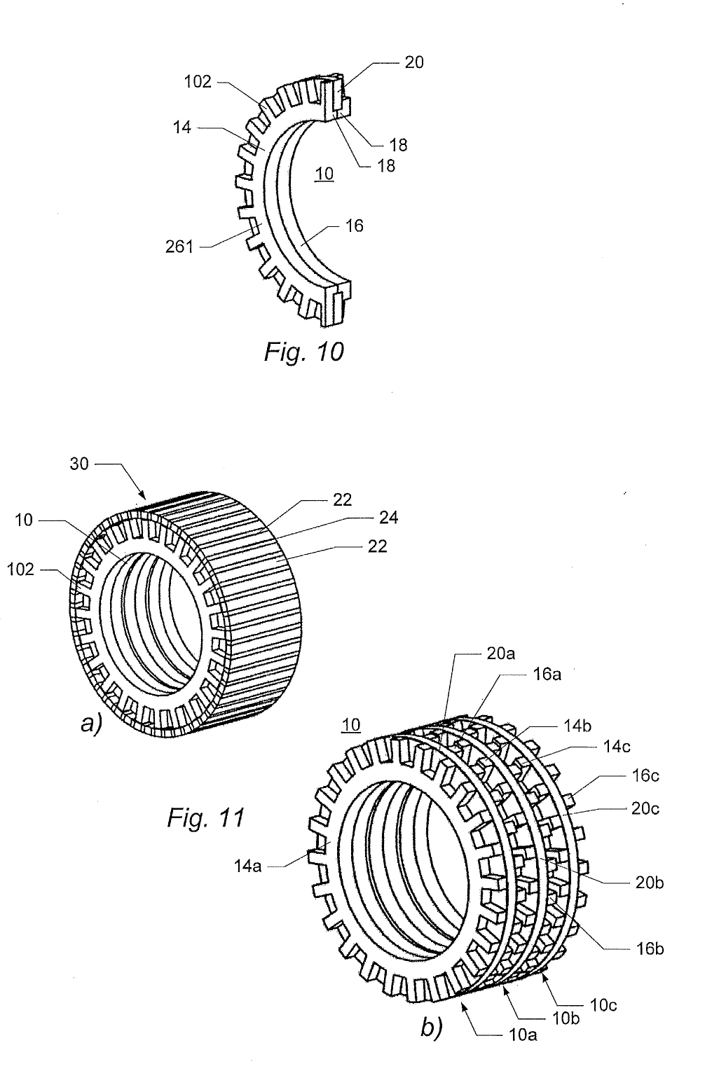

FIG. 10 illustrates an example of the stator 10 of the modulated pole machine of FIG. 9. In particular, FIG. 10 shows a cut-view of the stator 10.

The machine comprises a stator 10 which comprises a central single winding 20 that magnetically feeds multiple teeth 102 formed by a soft magnetic core structure. The stator core is formed around the winding 20 while for other common electrical machine structures the winding is formed around the individual tooth core section. More particularly the modulated pole electric machine of FIGS. 9 and 10 comprises two stator core sections 14, 16 each including a plurality of teeth 102 and being substantially annular, a winding 20 arranged between the first and second annular stator core sections, and a rotor 30 including a plurality of permanent magnets 22. Further, the stator core sections 14, 16, the coil 20 and the rotor 30 are encircling a common geometric axis, and the plurality of teeth 102 of the two stator core sections 14, 16 are arranged to protrude towards the rotor 30 for forming a closed circuit flux path. The stator teeth of the two stator core sections 14, 16 are circumferentially displaced in relation to each other.

Each stator section comprises an annular core back portion 261 providing a circumferential flux path between neighbouring teeth. The stator further comprises a flux bridge or yoke component 18 providing at least an axial flux path between the two stator core sections. In the machine in FIGS. 9 and 10 the stator teeth protrude in a radial direction towards the rotor, in this case with the rotor surrounding the stator. However, the stator could equally well be placed exteriorly with respect to the rotor. Embodiments of the rotor described herein may be used in single and/or in multi-phase machines.

The active rotor structure 30 is built up from an even number of segments 22, 24 wherein half of the number of segments—also called rotor pole sections 24—is made of soft magnetic material and the other half of the number of segments is made of permanent magnetic material 22. These segments may be produced as individual components. For illustration purposes, only the magnetically active parts of the rotor are shown in FIGS. 9-10. The tubular support structure described herein is not explicitly shown in FIGS. 9-10.

The permanent magnets 22 are arranged so that the magnetization directions of the permanent magnets are substantially circumferential, i.e. the north and the south poles, respectively, face in a substantially circumferential direction. Further, every second permanent magnet 22, counted circumferentially is arranged having its magnetization direction in the opposite direction in relation to its neighbouring permanent magnets. The magnetic functionality of the soft magnetic pole sections 24 in the desired machine structure is fully three dimensional and each soft magnetic pole section 24 is able to efficiently carry varying magnetic flux with high magnetic permeability in all three space directions.

This design of the rotor 30 and the stator 10 has the advantage of enabling flux concentration from the permanent magnets 22 so that the surface of the rotor 30 facing a tooth of the stator 10 may present the total magnetic flux from both of the neighboring permanent magnets 22 to the surface of the facing tooth. The flux concentration may be seen as a function of the area of the permanent magnets 22 facing each pole section 24 divided with the area facing a tooth. In particular, due to the circumferential displacement of the teeth, a tooth facing a pole section results in an active air gap that only extends partly across the axial extent of the pole section. Nevertheless, the magnetic flux from the entire axial extent of the permanent magnets is axially and radially directed in the pole section towards the active air gap. These flux concentration properties of each pole section 24 make it possible to use weak low cost permanent magnets as permanent magnets 22 in the rotor and makes it possible to achieve very high air gap flux densities. The flux concentration may be facilitated by the pole section being made from magnetic powder enabling effective three dimensional flux paths. Further, the design also makes it possible to make more efficient use of the magnets than in corresponding types of machines.

Still referring to FIGS. 9 and 10, the single phase stator 10 may be used as a stator of a single-phase machine as illustrated in FIGS. 9 and 10, and/or as a stator phase of a multi-phase machine, e.g. one of the stator phases 10a-c of the machine of FIG. 11. The stator 10 comprises two identical stator core sections 14, 16, each comprising a number of teeth 102. Each stator core section is made of soft magnetic powder, compacted to shape in a press tool. When the stator core sections have identical shapes, they may be pressed in the same tool. The two stator core sections are then joined in a second operation, and together form the stator core with radially extending stator core teeth, where the teeth of one stator core section are axially and circumferentially displaced relative to the teeth of the other stator core section.

Each of the stator core sections 14, 16 may be compacted in one piece. Each stator core section 14, 16 may be formed as an annular disc having a central, substantially circular opening defined by a radially inner edge 551 of an annular core back portion 261. The teeth 102 protrude radially outward from a radially outer edge of the annular disc-shaped core back. The annular part between the inner edge 551 and the teeth 102 provides a radial and circumferential flux path and a side wall of a circumferential cavity accommodating the coil 20. Each stator core section comprises a circumferential flange 18 at or near the inner edge 551. In the assembled stator the circumferential flange 18 is arranged on the inner side of the stator core section, i.e. the side facing the coil 20 and the other stator core section. In the embodiment shown in FIGS. 9 and 10, the stator core sections 14, 16 are formed as identical components. In particular both stator core sections comprise a flange 18 protruding towards the respective other stator core section. In the assembled stator, the flanges 18 abut each other and form an axial flux bridge allowing the provision of an axial magnetic flux path between the stator core sections. In the assembled stator for an outer rotor machine the coil thus encircles the stator core back formed by flanges 18.

Each of the teeth 102 has an interface surface 262 facing the air gap. During operation of the machine, the magnetic flux is communicated through the interface surface 262 via the air gap and through a corresponding interface surface of a pole piece of the rotor.

FIG. 11a illustrates the active parts of an example of a 3-phase modulated pole machine, while FIG. 11b shows an example of a stator of the machine of FIG. 11a. The machine comprises a stator 10 and a rotor 30. The stator 10 contains 3 stator phase sections 10a, b, c each as described in connection with FIGS. 9 and 10. In particular each stator phase section comprises a respective stator component pair 14a, 16a; 14b, 16b; and 14c, 16c, respectively, each holding one circumferential winding 20a-c, respectively.

Hence, as in the example of FIGS. 9 and 10, each electric modulated pole machine stator phase section 10a-c of FIG. 11 comprises a central coil 20a-c, e.g. a single winding, that magnetically feeds multiple teeth 102 formed by the soft magnetic core structure. More particularly, each stator phase 10a-c of the shown electric modulated pole machine 100 comprises two stator core sections 14, each including a plurality of teeth 102 and being substantially annular, a coil 20 arranged between the first and second circular stator core sections. Further, the stator core sections 14 and the coil 20 of each stator phase encircle a common axis, and the plurality of teeth 102 of the stator core sections 14 are arranged to protrude radially outward. In the example of FIG. 11 the rotor 30 is arranged coaxially with the stator 10 and encircling the stator so as to form an air gap between the teeth 102 of the stator and the rotor. The rotor may be provided as alternating permanent magnets 22 and pole pieces 24 as described in connection with FIGS. 9 and 10, but axially extending across all stator phase sections.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

Embodiments of the invention disclosed herein may be used for a direct wheel drive motor for an electric-bicycle or other electrically driven vehicle, in particular a light-weight vehicle. Such applications may impose demands on high torque, relatively low speed and low cost. These demands may be fulfilled by a motor with a relatively high pole number in a compact geometry using a small volume of permanent magnets and wire coils to fit and to meet cost demands by the enhanced rotor assembly routine.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A rotor for a modulated pole machine, the rotor being configured to generate a rotor magnetic field for interaction with a stator magnetic field of a stator of the modulated pole machine, wherein said rotor comprises:
a tubular support structure defining a circumferential mounting surface, the tubular support structure comprising a plurality of elongated recesses in the mounting surface, the elongated recesses extending in an axial direction of the tubular support structure, and
a plurality of permanent magnets magnetised in the circumferential direction of said rotor so as to generate the rotor magnetic field, the permanent magnets being separated from each other in the circumferential direction of the rotor by axially extending rotor pole sections for directing the rotor magnetic field generated by said permanent magnets in at least a radial direction, wherein the permanent magnets extend radially at least partly into respective ones of the plurality of recesses and a respective rotor pole section is placed between two adjacent permanent magnets.

2. A rotor according to claim 1, wherein the plurality of recesses are adapted to allow the position of the permanent magnets to be adjusted radially so as to allow the radial length of a part of each permanent magnet extending out of the recess to be adjusted.

3. A rotor according to claim 1, wherein each permanent magnet is in contact with two side walls of said recess.

4. A rotor according to claim 1, wherein the permanent magnets are fitted inside the recesses of the tubular support structure by a frictional fit formed by the side walls of said recess.

5. A rotor for a modulated pole machine, the rotor being configured to generate a rotor magnetic field for interaction with a stator magnetic field of a stator of the modulated pole machine, wherein said rotor comprises:
a tubular support structure defining a circumferential mounting surface, the tubular support structure comprising a plurality of elongated recesses in the mounting surface, the elongated recesses extending in an axial direction of the tubular support structure, and
a plurality of permanent magnets magnetised in the circumferential direction of said rotor so as to generate the rotor magnetic field, the permanent magnets being separated from each other in the circumferential direction of the rotor by axially extending rotor pole sections for directing the rotor magnetic field generated by said permanent magnets in at least a radial direction, wherein at least one rotor pole section extends radially at least partly into one of the plurality of recesses;
wherein a rotor pole section when fitted in a recess of said support structure extends radially from said recess defining a radial axis, wherein the rotor pole section comprises,
a first constant-width zone, forming a first end of said rotor pole sections, adapted to at least partly be fitted in a recess of said support structure wherein said first constant-width zone has two parallel side walls so that the width of the rotor pole section in said first constant-width zone is constant,
a tapered zone starting at the point where the first constant-width zone ends, wherein said tapered zone has two non-parallel side walls such that the width of said rotor pole section in said tapered zone is non constant.

6. A rotor according to claim 5, wherein the rotor pole section further comprises a second constant-width zone starting at the point where the tapered zone ends, and forming a second end of said rotor pole section, wherein the side walls of said second constant-width zone is parallel, so that the width of said rotor pole section is constant in said second constant-width zone.

7. A rotor according to claim 5, wherein the plurality of recesses are adapted to allow the position of the rotor pole sections to be adjusted radially so as to allow the radial length of a part of each rotor pole section extending out of the recess to be adjusted.

8. A rotor according to claim 5, wherein the rotor pole sections are fitted inside the recesses of the tubular support structure by a frictional fit formed by the side walls of said recess.

9. A rotor according to claim 1, wherein the circumferential mounting surface is the inner surface of the tubular support structure.

10. A rotor according to claim 1, wherein the circumferential mounting surface is the outer surface of the tubular support structure.

11. A rotor according to claim 1, wherein the rotor pole sections are made from a soft magnetic material.

12. A rotor according to claim 1, wherein the tubular support structure is made of a non-magnetic material such as aluminium, or plastic.

13. A rotor pole section comprising:
a first constant-width zone, forming a first end of said rotor pole section, adapted to at least partly be fitted in a recess of a support structure wherein said first constant-width zone has two parallel side walls so that the width of the rotor pole section in said first constant-width zone is constant,
a tapered zone starting at the point where the first constant-width zone ends, wherein said tapered zone has two non-parallel side walls such that the width of said rotor pole section in said tapered zone is non constant.

14. A rotor pole section according to claim 13, wherein the rotor pole section further comprises a second constant-width zone starting at the point where the tapered zone ends, and forming a second end of said rotor pole section, wherein the side walls of said second constant-width zone are parallel, so that the width of said rotor pole section is constant in said second constant-width zone.

15. A method of manufacturing a rotor pole section according to claim 13 using powder compaction, comprising the steps of:
obtaining a die having the inverse shape of a rotor pole section comprising a first constant-width zone and a second constant-width zone;
filling said die with magnetic powder;
compressing the magnetic powder in the die using at least two punches, wherein at least one of the punches moves against the other punch along the radial axis of the resulting rotor pole section, partly entering at least one of the first constant-width zone or the second constant-width zone of the die, such that the length of at least one of the first constant-width zone or second constant-width zone of the resulting rotor pole section is reduced.

16. A method for manufacturing a rotor for a modulated pole machine, said rotor comprising a tubular support structure defining a circumferential mounting surface, the tubular support structure comprising a plurality of elongated recesses positioned periodically along the mounting surface of the support structure in the mounting surface, the elongated recesses extending in an axial direction of the tubular support structure, each recess having two side walls, the rotor further comprising a plurality of permanent magnets separated in the circumferential direction from each other by axially extending rotor pole sections made from soft magnetic material, wherein the method comprises the steps of:
placing either a permanent magnet or a rotor pole section at least partly inside each of the recesses, the permanent magnets or rotor pole sections extending radially out of the recesses thereby forming a plurality of slots between two adjacent recesses
placing either a permanent magnet or a rotor pole section inside each of the formed slots.

17. A method according to claim 16, wherein the method further comprises the step of placing an air-gap fixture concentric with the support structure, wherein a rotor pole section or a permanent magnet is adjusted radially in a recess so that the side of the permanent magnet or rotor pole section facing the air-gap-fixture contacts said air-gap-fixture.

18. A method for manufacturing a rotor for a modulated pole machine according to 17, wherein the air-gap fixture further comprises a magnetic device for strengthen the contact pressure between a rotor pole section or a permanent magnet and the air-gap-fixture.

19. A modulated pole machine comprising a stator and a rotor as defined in claim 1, wherein the stator comprises
first and second stator core sections, each including a plurality of teeth radially protruding towards the rotor, and
a winding arranged between the first and second stator core sections;
wherein the teeth of the second stator core section are circumferentially displaced in relation to the teeth of the first stator core section, wherein the axially extending rotor pole sections that separate the permanent magnets extend axially to both the first and second stator core sections,
and the magnetization direction of the permanent magnets of the rotor is substantially circumferential so as to cause the magnetic flux path generated in an axially extending pole section during use of the modulated pole machine to extend at least circumferentially and axially and to concentrate the magnetic flux from a facing area of the adjacent permanent magnets to a position of a tooth of one of the stator sections, and wherein the magnetization direction of every second permanent magnet is opposite to the magnetization direction of the permanent magnets in between.

20. A rotor according to claim 5, wherein the circumferential mounting surface is the inner surface of the tubular support structure.

21. A rotor according to claim 5, wherein the circumferential mounting surface is the outer surface of the tubular support structure.

22. A rotor according to claim 5, wherein the rotor pole sections are made from a soft magnetic material.

23. A rotor according to claim 5, wherein the tubular support structure is made of a non-magnetic material such as aluminium, or plastic.
